(19) United States
(12) Patent Application Publication
(10) Pub. No.: US 2003/0041758 A1
(43) Pub. Date: Mar. 6, 2003

(54) Method for producing an imaged and reimageable printing plate

(75) Inventors: Arndt Jentzsch, Coswig (DE); Reinhard Nerger, Radebeul (DE)

Correspondence Address: Alison B. Kessler, Goodwin Procter LLP, Counsellors at Law, Seven Becker Farm Road, Roseland, NJ, 07068, US

(73) Assignee: Koenig & Bauer, AG

(21) Appl. No.: 10/236,086

(22) Filed: Sep. 6, 2002

(30) Foreign Application Priority Data
Sep. 6, 2001 (DE) 101 43 626.2

(51) Int. Cl. B41C 1/00; B41N 6/00

(52) U.S. Cl. 101/401.1

(57) ABSTRACT

The present invention relates to a method for producing an imaged and reimageable printing plate for multicolored printing using the digital imaging technique.

There is provided a method for producing imaged and reimageable printing plates, which ensures the register accuracy of a multicolored printing without great expense and with which reimageable printing plates can be produced with little economic cost, especially for large formats.

Printing plates in a printing press, which have concluded their printing tasks, are removed from the printing form cylinders, passed on to a device which neutralizes them, and the neutralized printing plates are coated, the coated printing plates are mounted once again on the printing form cylinders and the printing plates are digitally imaged in the printing press and developed.

The present invention relates to a method for producing an imaged and reimageable printing plate for multicolored printing using a digital imaging technique.

It is well known that the direct imaging of printing forms from a digital data inventory of a prepress can be carried out by transferring all digital image data for all printing inks to printing plates outside of a printing press (computer-to-plate). The printing plates are inserted in the printing press after the imaging.

The simultaneous transfer of the digital image data for all printing inks on printing plates in the printing press is also known. This is accomplished with a disposable, imageable printing form or with a reimageable printing form (computer-to-press).

In the prior art, when reimageable printing forms are used, the image is erased after printing, the surface on the printing plate is neutralized and the image for the next printing order is applied. This method is very time consuming and process intensive since the equipment for both neutralization and imaging must be used several times in a multicolor printing press and the individual steps of the process take place consecutively. The printing press is not available for printing while the printing plates are being processed. (Kipphahn, Handbuch der Druckmedien (Handbook of Printing Media), Springer Verlag, 2000, pages 607-610). Therefore, this method does not represent a solution for large format, multicolored printing.

DE 100 04 573 A1 also discloses a method for producing imaged printing plates. According to this publication, the imaging occurs in a manner such that the printing plate, which has concluded its printing task, is removed from the printing form cylinder, passed on to a device for neutralizing and neutralized. The printing plate is fixed in register in exposing and developing equipment, exposed and developed and the imaged printing plate is mounted once again on the printing form cylinder.

It is a disadvantage of this method of imaging that the printing plates, imaged outside of the printing press, must be clamped with great care and in register on the printing form cylinder, so that the multicolored printing can be applied congruently on the sheet.

DE 41 29 022 A1 discloses providing magazines for automatically exchanging printing plates for loading printing form cylinders with printing plates. A cassette, which contains several imaged printing plates for individual printing orders, is pushed into the magazine, which is mounted on the printing unit. The printing plates are exchanged automatically.

It is also generally known that form cylinders may be provided with a sleeve, which itself functions as a printing form or is provided with the printing form. The sleeve or the printing form mounted on the sleeve can be used repeatedly. The reimaging can take place in the machine. (Kipphahn, page 675).

It is an object of the present invention to provide a method for producing imaged and reimageable printing plates, which ensures the register accuracy of a multicolored printing without great expense, and with which reimageable printing plates can be produced with little economic cost, especially for large formats.

The inventive method was created with the knowledge that the computer to press/direct imagining process with reimageable printing plates/printing forms offers many technical advantages. The printing form is produced in a clamping device for printing, thus ensuring the register accuracy of the multicolored printing.

Pursuant to the present invention, the process of producing the printing plates in the printing press is carried out off-line. The printing plate, which has concluded its printing task, is neutralized and, if necessary, the printing plate is coated outside of the printing press. Thus, additional time is available as productive time for printing and the process of producing the printing plates can be carried out while the machine is printing.

The imagining itself takes place in the printing press. This corresponds to the clamping of the printing plate on the form cylinder, in which the printing is carried out. As a result, the register accuracy of the multicolored printing is ensured. It, therefore, becomes unnecessary to position the printing plates accurately or to align them with respect to one another. These advantages exist also when the sleeve technique is used.

In another embodiment of the present invention, there is an automatic mechanism for changing printing plates, for example, a magazine or cassette, in which the printing plates prepared for the coating for the individual printing orders are held. Here, the advantage arises that the printing plates are not yet imaged. A change in the sequence of attending to printing orders affects only the process of digital imaging, but not the course of loading the form cylinder with printing plates. In other words, there is no need to sort the printing plates in the magazine or cassette once again when the printing sequence is changed.

It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute terms, such as, for example, “will,” “will not,” “shall,” “shall not,” “must,” and “must not,” are not meant to limit the scope of the present invention as the embodiments disclosed herein are merely exemplary.

Aspects of the present invention are explained in greater detail by means of examples.

At the end of a multicolored printing process in a printing press, the printing plates, which have completed their printing task, are removed from the printing form cylinders on which they are clamped. This may be done advantageously with an automatic device for changing plates, with which the printing plates that have completed their printing task are removed from the printing form cylinders and the new printing plates are supplied to the printing form cylinders.

The printing plates, which have completed their printing tasks, are now passed on to a device for neutralizing, where they are neutralized. Neutralization is understood to be the removal of the printed image from the printing plates. This may be accomplished chemically, mechanically or thermally or by any known suitable method, and preferably with a laser technique. An almost identical surface tension may be achieved with the neutralization.

If the printing unit has a magazine for printing plates, printing plates in the magazine, which have completed their printing tasks, are removed from the machine and neutralized.

If the printing form/printing plate is constructed on the basis of the sleeve technique, the sleeve can be pulled from the form cylinder or the cylinder with the sleeve can be removed from the printing press and neutralized as described above.

After the neutralization, the printing plates may be supplied directly to the printing form cylinder in the printing press or the printing form cylinder may be provided with the sleeve and then installed in the press.

In printing units with magazines or cassettes, the latter are loaded with one or several neutralized printing plates.

If the neutralization of the printing plates is associated with a coating process, the printing plates, including those employing the sleeve technique, are coated, for example, with a lacquer and a photosensitive material or a heat sensitive layer or any other known suitable coating, and then supplied to the printing press, as required.

In the printing press, the printing plates are imaged. The imaging may be accomplished digitally using digital data sets (CtP), for example. Laser imaging equipment may be employed for the imaging.

The printing plate used in the present method, preferably consists of stainless steel, is dimensionally stable, free of disks and may have further surface finishes, which are known for offset printing (such as chromium, ceramic layers or the like). However, other materials can also be used for the printing plate (film). Preferably, the material used for the printing plate can be re-used. A film in the form of a roll can also be used.

Accordingly, a benefit of the present invention is that plate costs are reduced to only a fraction of those in classical technology, plates are coated and recoated outside of the press without interfering with the offset process and a precise stand accuracy is achieved by digital imaging in the press.

Having now described one or more exemplary embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

What is claimed is:

1. A method for producing at least one imaged and reimageable printing plate for multicolored printing in printing presses, comprising the steps of:
removing from at least one printing form cylinder at least one printing plate in a printing press that has concluded at least one printing task;
passing said at least one printing plate on to a device for neutralizing;
neutralizing said at least one printing plate;
coating said at least one neutralized printing plate;
mounting said at least one coated printing plate on said at least one printing form cylinder;
digitally imaging said at least one printing plate in said printing press; and
developing said at least one digitally imaged printing plate.

2. The method of claim 1, further comprising:
supplying said at least one neutralized printing plate to a printing unit with a printing plate magazine or cassette.

3. The method of claim 1, wherein said at least one printing plate is based on sleeve technique.

4. The method of claim 1, wherein said removing step and said mounting step occur by means of a device for changing plates automatically.

5. The method of claim 1, wherein said neutralizing is carried out by means of a laser technique.

6. A method for producing at least one imaged and reimageable printing plate for multicolored printing in printing presses, comprising the steps of:
removing from at least one printing form cylinder at least one printing plate in a printing press that has concluded at least one printing task;
passing said at least one printing plate on to a device for neutralizing;
neutralizing said at least one printing plate;
mounting said at least one neutralized printing plate on said at least one printing form cylinder;
digitally imaging said at least one printing plate in said printing press; and
developing said at least one digitally imaged printing plate.

7. The method of claim 6, wherein said at least one printing plate is based on sleeve technique.

8. The method of claim 6, wherein said removing step and said mounting step occur by means of a device for changing plates automatically.

9. The method of claim 6, wherein said neutralizing is carried out by means of a laser technique.
